(19) United States
(12) Patent Application Publication
(10) Pub. No.: US 2006/0102653 A1
(43) Pub. Date: May 18, 2006

(54) Audio dispensing pump

(76) Inventor: Lynn Allyson Edwards, Oak Park, CA (US)

Correspondence Address: LYNN EDWARDS, 6077 MANDEVILLE PLACE, OAK PARK, CA, 91377, US

(21) Appl. No.: 10/987,932

(22) Filed: Nov. 15, 2004

(51) Int. Cl. B67D 5/32

(52) U.S. Cl. 222/39

(57) ABSTRACT

The nature of the technical disclosure of this invention is a pre-programmed sound component that is embedded in the top portion of a dispensing pump. This feature is novel in the art to which the invention pertains, as there are currently no dispensing pumps that emit sound as pressure is exerted to the top component of the dispensing pump. This audio feature is what sets this invention apart from existing technology.

### CROSS-REFERENCE TO RELATED APPLICATIONS

This non-provisional patent application claims the benefit of already filed U.S. Pat. No. 6,729,505.

### FIELD OF INVENTION

This patents pertains to the field of personal hygiene and aims to encourage proper and consistent hygiene behaviors amongst children.

### DESCRIPTION OF PRIOR ART

The current dispensing technology used for personal hygiene is merely functional, without having a built in “encouraging” utility mechanism that involves sound. Therefore, it will take the current technology to a new level of function and utility.

### BRIEF SUMMARY OF INVENTION

The invention is called the “Audio Dispensing Pump.” It is a sound producing dispensing pump. The spout or top of the pump (where the soap or cleanser emerges) contains a sound component. When the top/head of the pump is pressed down, the cleanser emerges along with a sound. The pressing of the top of the pump puts pressure on a switch that activates a sound component programmed with a specific sound or sounds. The type of sound is limitless and includes any and all sounds/words/phrases etc. . . .

The purpose of this invention is to encourage good hygiene habits in children and to provide an educational and entertainment value to children when washing their hands, face, or body. For example, a dispensing pump that is situated in a dispensing container shaped like a duck may sound out “quack, quack” once the top is pressed down. This will not only bring entertainment to children and make personal hygiene fun, but it can also teach them what a duck sounds like. The current technology for dispensing pumps offer no audio stimulation. U.S. Pat. No. 6,223,939 added visual stimulation to the dispensing pump, but no sound. This invention is primarily geared toward, but not limited to children. Adults may find the utility value of this invention irresistible too.

### BRIEF DESCRIPTION OF THE VIEW OF THE DRAWING

FIG. 1A shows a drawing of the dispensing pump, which has three main components. First is the dispensing pump head, where the cleanser emerges. The second is the programmed sound component, which is located in the dispensing pump head. The third component is the tube, whereby the cleanser is retrieved from the container in which the dispensing pump is inserted. This existing technology, minus the sound component, exists under U.S. Pat. No. 6,729,505.

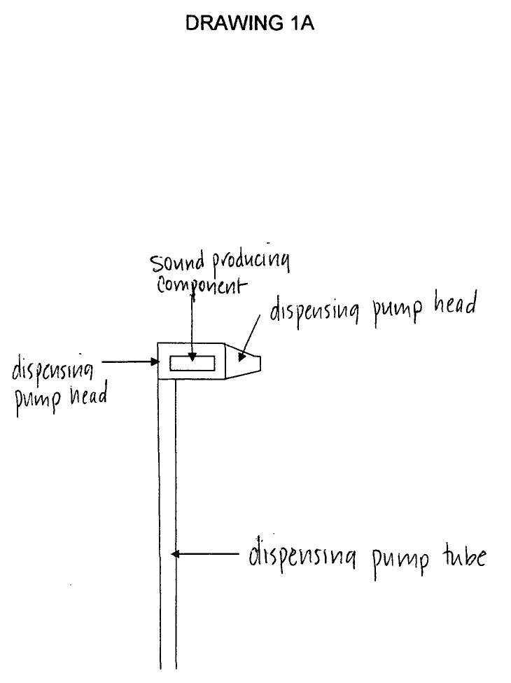

### DETAILED DESCRIPTION OF THE INVENTION

The Audio Dispensing pump is a device by which a cleansing liquid is extracted from a container by putting pressure on the top of the dispensing unit. The cleanser runs up through the dispensing tube and emerges from the top of the dispensing pump head. As pressure is exerted on the dispensing pump head, a sound emerges simultaneously with the cleanser. It is the sound component, located in the head of the dispensing pump, that represents the improvement component of this invention over existing ones.

What distinguishes this device from existing dispensing pumps is its audio element. Some existing dispensing pumps offer visual stimulation, but none offer the utility of sound. By offering an audio element to this current technology, the “Audio Dispensing Pump” can provide an educational and entertainment value that the current pumps cannot. Because sounds and words will be reinforced to children at every use, they will be provided with a unique and consistent way of learning. Therefore, this invention not only has the ability to teach, but also to reinforce time and time again. The entertainment value of the “Audio Dispensing Pump” will also encourage children to maintain good hygiene and will discourage forgetfulness when it comes to keeping clean. Another advantage to this invention that distinguishes it from existing pumps is that it encourages dialogue between parent/guardian and child. When the child reacts to the sound, it will promote a response from the caregiver who may go into more detail about the sound or source of the sound. The sounds generated by the “Audio Dispensing Pump” are not limited to those found enjoyable or educational to children. The pump may provide sounds/words/phrases that are applicable and bring utility to adults as well.

1. What I claim as my invention is a sound producing dispensing pump. This invention is to encompass any and all types of sounds ie: music, words, phrases, etc. . . . The sound comes from a pre-programmed audio component that lies at the top of the dispensing pump and emits sound as pressure is exerted upon the top of the dispensing pump.
